(19) United States
(12) Patent Application Publication
(10) Pub. No.: US 2006/0242423 A1
(43) Pub. Date: Oct. 26, 2006

(54) ISOLATED AUTHENTICATION DEVICE AND ASSOCIATED METHODS

(76) Inventor: John Wesley Kussmaul, Weston, MA (US)

Correspondence Address: W. EDWARD RAMAGE, COMMERCE CENTER SUITE 1000, 211 COMMERCE ST, NASHVILLE, TN, 37201, US

(21) Appl. No.: 11/382,168

(22) Filed: May 8, 2006

Related U.S. Application Data
(63) Continuation-in-part of application No. 11/379,613, filed on Apr. 21, 2006.
(60) Provisional application No. 60/674,145, filed on Apr. 22, 2005.

(51) Int. Cl. H04L 9/00

(52) U.S. Cl. 713/182

(57) ABSTRACT

An isolated authentication device and related methods to provide a reliable means of authenticating the identity of its user to a network resource or server or other resource, and of authenticating the identity of a network resource or server or other resource to the device's user. The isolated authentication device may be attached to or in communication with a host device, such as a mobile telephone, personal digital or data assistant, GPS multifunction device, portable music player, wristband watch, personal computer, or similar device. A constrained operating system provides limited functionality, including authentication, data transfer, and cryptographic functions. Encrypted image, fingerprint, password, and/or personal identification number data is stored in read-only or protected nonvolatile memory. Input may be provided by means of a numeric or alphanumeric keypad, and images and information may be displayed on a screen. The device may be used to digitally sign a document, or a key to a lock.

This application is a continuation-in-part of U.S. patent application Ser. No. 11/379,613, filed Apr. 21, 2006, by John Wesley Kussmaul, which claims benefit of the previously filed Provisional Patent Application No. 60/674,145, filed Apr. 22, 2005 by John Wesley Kussmaul, and is entitled to those filing dates for priority in whole or in part. The specification and drawings of Provisional Patent Application No. 60/674,145 and U.S. Utility application Ser. No. 11/379,613 are incorporated herein by specific reference.

### FIELD OF INVENTION

This invention relates to a device and method for user authentication. More particularly, the present invention relates to a device and associated methods for authenticating the identity of a user to a network resource or other resources and for authenticating the identity of a network resource or other resources to the device's user.

### BACKGROUND OF INVENTION

The problem of authentication of parties doing business or communicating over the Internet or similar networks is well known. A variety of false or spoofed web sites have been used to deceive and defraud various users that the site is a site for a genuine business when it really is not. Similarly, a user can pretend to be someone other than they are, often using purloined passwords, personal identification numbers (PINs), or similar identifiers.

Some web sites provide some form of certificate to allow a user to verify that a web site is authentic, or place a certificate or cookie on the user's computer to prove their authenticity. However, the procedures for performing this form of authentication can be complex and unwieldy, and too difficult to use for most individuals. Gasparini, et al. (U.S. patent application Ser. No. 10/435,322) discloses a method of using a signed, encrypted cookie on the user's system to allow a web site to authenticate a user. However, such a system may still be vulnerable to the cookie being copied or duplicated, and is limited to particular systems using cookies.

Thus, what is needed is a independent authentication device that connects to or communicates with a variety of systems or host devices, and can easily and accurately authenticate a web site or server to a user, and vice versa, without storing any security data or cookie on the user's system or host device.

### SUMMARY OF THE INVENTION

The present invention relates to a device and related methods for providing an independent authentication device that connects to or communicates with a variety of host devices or systems. The authentication device can securely authenticate the user to a web site or server, and conversely, securely authenticate a web site or server to a user. Encrypted data, which may include an image file, fingerprint or biometric data, passwords, and/or PINs, and asymmetric key data, are stored in protected nonvolatile memory in the authentication device. Certain pieces of this data may be provided to a web site or server, and used in the authentication procedures. The device may also be used to digitally sign a documents, or be used a key for a lock.

### DESCRIPTION OF THE DRAWINGS

FIG. 1 shows a top and side view of one embodiment of the present invention with a USB connector.

FIG. 2 shows a top and side view of another embodiment of the present invention with wireless connection.

FIG. 3 shows a top view of another embodiment of the present invention with a numeric keypad.

FIG. 4 shows a top view of the interior of another embodiment of the present invention.

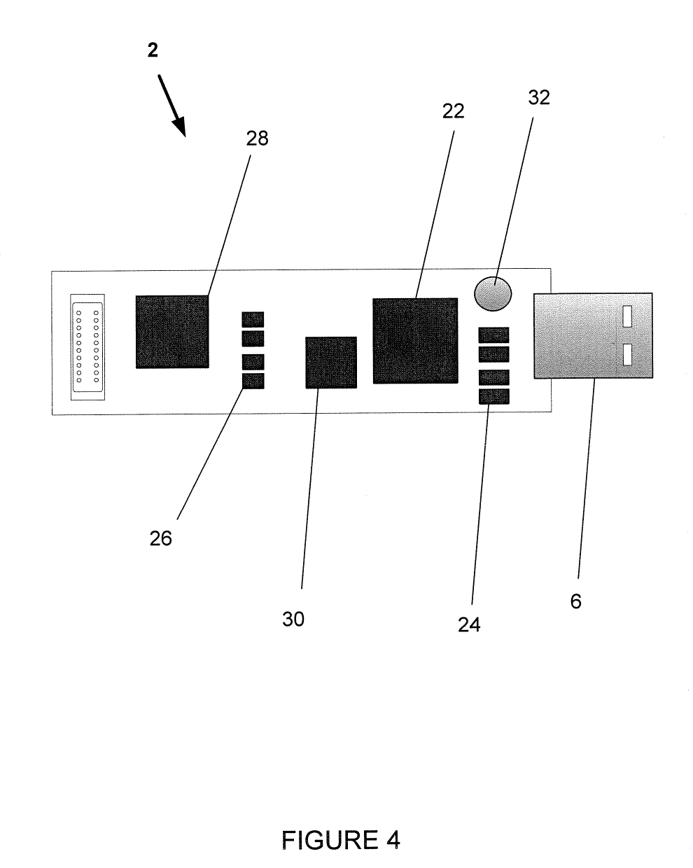

FIG. 5 shows various steps in the process of initiating an authentication device in accordance with an embodiment of the present invention.

FIG. 6 shows various steps in the use of an authentication device in accordance with an embodiment of the present invention.

FIG. 7 shows various steps in the use of an authentication device to digitally sign a document in accordance with an embodiment of the present invention.

FIG. 8 shows various steps in the use of an authentication device as a key in accordance with an embodiment of the present invention.

### DESCRIPTION OF THE INVENTION

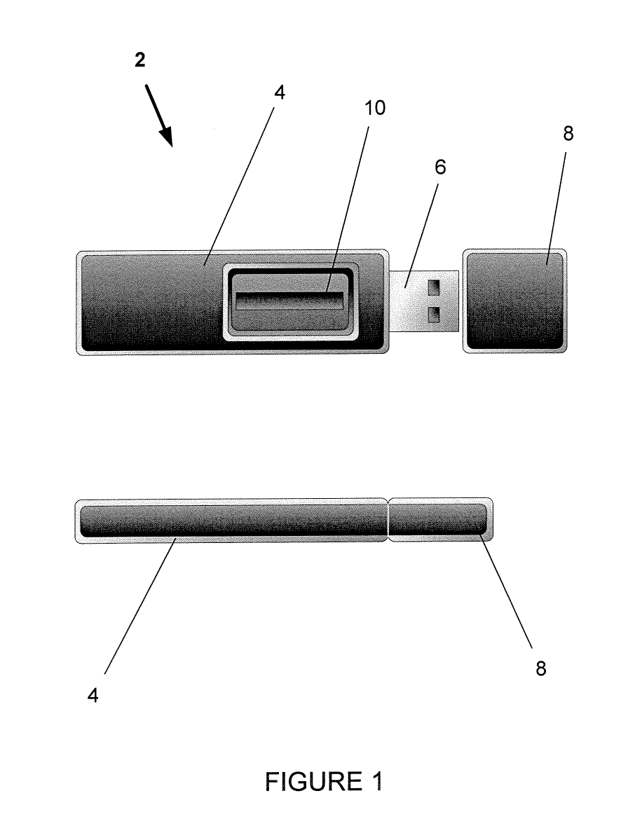

Referring now to the numerous figures, wherein like references identify like elements of the invention, FIG. 1 shows an isolated authentication device 2 in accordance with one exemplary embodiment of the present invention. The isolated authentication device 2 may be of any size and shape. In various exemplary embodiments, as seen in FIGS. 1-3, the device may be about the size and shape of a Universal Serial Bus (USB) memory stick or key chain, a smart card, a credit card, or a small calculator. In general, the isolated authentication device 2 comprises a shell 4, and external or internal connection or communications means 6. A cap 8 may be used, when appropriate, to cover the connection means (such as the USB connector shown in FIG. 1).

The device 2 also may incorporate or be attached to a fingerprint reader or biometric sensor 10. Various embodiments also may have a display 12 (which may be color or monochrome, and low or high resolution), and means for input, such as a keypad or set of keys (which may be alphanumeric or telephone-style) 14. The display 12 may also be used as input means, if the display screen is touch sensitive. The display 12 may be based on liquid crystal display (LCD), organic light-emitting diode (OLED), or polymeric light-emitting diode (PLED) technology. Some exemplary embodiments may include one or more signal lights or LEDs to indicate operating or connection status 16.

In one exemplary embodiment, the isolated authentication device 2 is portable, and attaches or connects to, or is in electronic communication with, some host device (not shown). The host device may be a mobile telephone, a personal data or personal digital assistant (PDA), a GPS multifunction device, portable music player, wristband watch, a personal computer, or some similar device. The means for connection or communication 6 can be any one or more of standard means for connection or communication, including but not limited to a USB connector, a USB plug for wired USB connection, wireless network, infrared, smart card interface (contact or contactless), Bluetooth, Cardbus, or Ethernet. Thus, the isolated authentication device 2 may or may not be physically attached or connected to the host device. In one exemplary embodiment, the isolated authentication device 2 may be enclosed in the same casing as the host device, in which case a shell 4 may not be needed.

The isolated authentication device 2 contains a processor 22, which is capable of cryptographic functions. The device 2 also may possess general nonvolatile memory or RAM or volatile memory, or some combination thereof 24, and isolated nonvolatile memory (ROM or flash RAM) or other storage means or some combination thereof 26. A separate cryptoaccelerator and/or a separate communication controller (such as, but not limited to, a Universal Asynchronous Receiver/Transmitter, or UART) may be provided, although these functions may be incorporated into the processor 22. The device 2 also may contain a separate fingerprint or biometric device controller 28 or display controller 30, where these functions are not already incorporated in the processor 22. Some or all types of the above memory may be incorporated with the processor, and possibly with other of the above functions, on a single chip. A power source, such as a battery 32, also may be used 4.

FIG. 1 shows an exemplary embodiment of an isolated authentication device 2 with a fingerprint reader, USB connector and cap. The overall length of this exemplary embodiment is approximately 3 inches, width is approximately 0.75 inches, and thickness is approximately 0.31 inches. The size of other similar embodiments may vary.

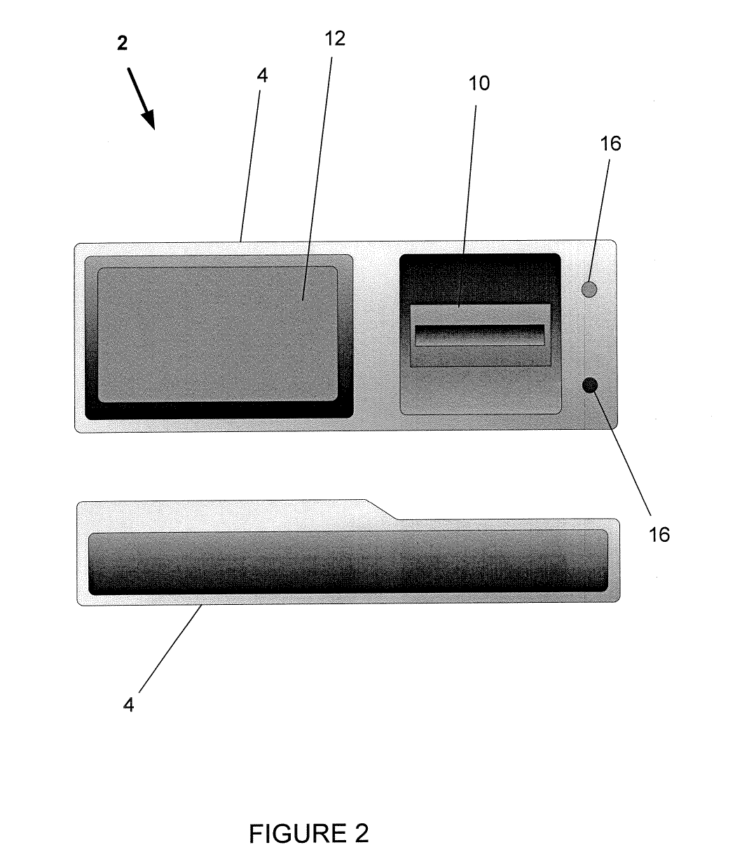

FIG. 2 shows another exemplary embodiment of an isolated authentication device with a fingerprint reader and display screen. Connection means may be wireless, Bluetooth, or infrared. The overall length of this exemplary embodiment is approximately 3.27 or 3.82 inches, width is approximately 1.14 or 1.18 inches, and thickness is approximately 0.62 inches. The size of other embodiments may vary.

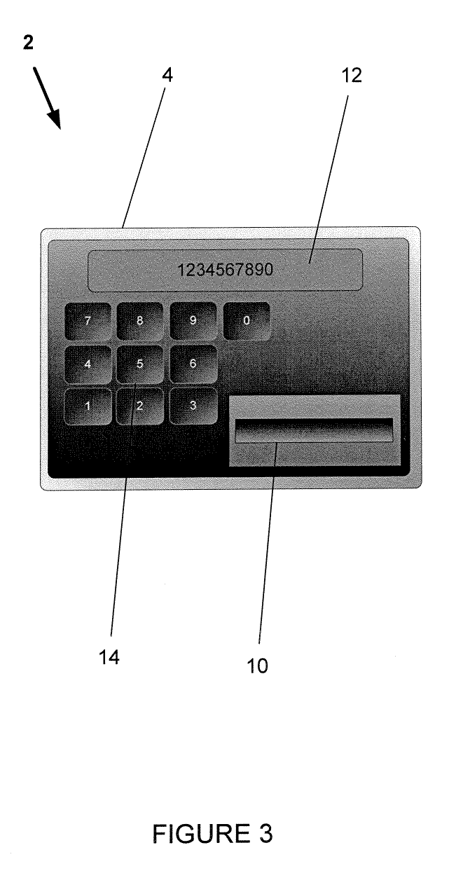

FIG. 3 shows another exemplary embodiment of an isolated authentication device with a fingerprint reader, numeric keypad and display screen. Connection means may be through a USB cable (not shown). The overall length of this exemplary embodiment is approximately 2.00 inches, and width is approximately 1.38 inches. The size of other embodiments may vary.

In one exemplary embodiment, the isolated authentication device 2 is run by a constrained operating system designed to eliminate or reduce the possibility of tampering or unauthorized access to files and instructions. The constrained operating system thus may provide only limited functions, including but not limited to taking input from the fingerprint reader or biometric sensor, taking input from the keypad, taking input from the display screen, releasing keys for internal use (after authentication of the user), and decryption/encryption operations. The constrained operating system cannot perform any general purpose operations, and excludes many typical operating system functions, such as application programming interfaces (APIs) and other facilities which serve to aid in programmability. Because the device 2 is designed to attach to or communicate with a host device that has its own multifunction operating system (such as for playing music, keeping calendars, providing email, and the like), there is no need for versatility in the device's 2 constrained operating system. For maximum security, the device 2 should not share a keypad, keyboard, fingerprint reader, biometric sensor, or display with the host device.

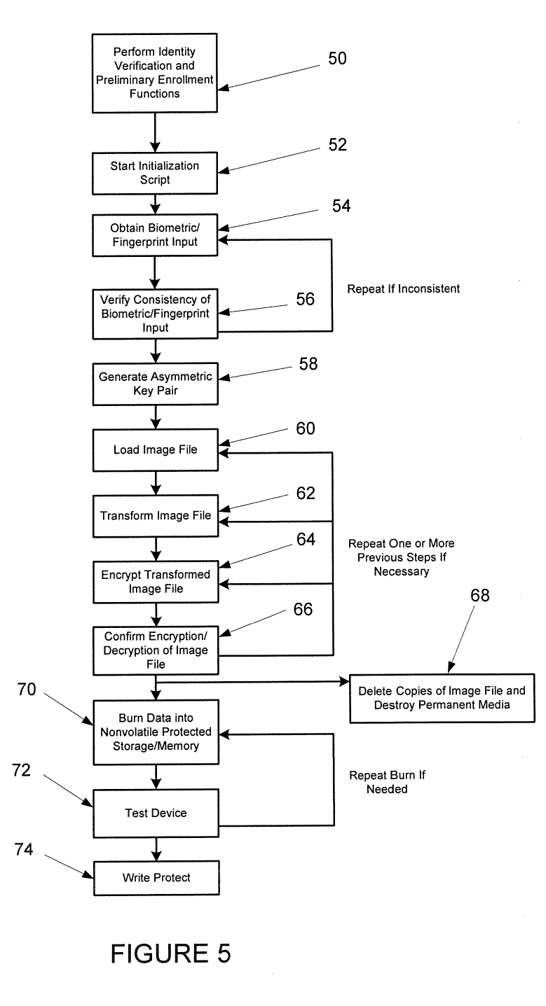

As shown in FIG. 5, use of the isolated authentication device 2 requires that it first be initialized. Initialization can be accomplished at a variety of computers or workstations. In an exemplary embodiment, initialization is accomplished at an enrollment workstation, which is a controlled-access personal computer. The enrollment workstation may be under the supervision of an enrollment officer. Where an enrollment officer is present, the enrollment officer performs any identity verification and other preliminary enrollment functions 50, and performs an initialization script 52 to produce files that will be transferred to the isolated authentication device 2. The enrollment officer takes input 54 from a fingerprint reader or biometric sensor attached to the enrollment workstation, and verifies that the fingerprint samples are consistent 56. In one exemplary embodiment, multiple samples are taken. In addition, the fingerprint reader or biometric sensor attached to the enrollment workstation may be identical or very similar in design to the fingerprint reader or biometric sensor in the isolated authentication device for greater accuracy and later efficiency. Upon verifying that fingerprint samples are consistent, the enrollment workstation is used to generate an asymmetric key pair 58 comprising a public key and a private key. If an enrollment officer is not present, some or all of the above steps may be taken by the individual user, or enrollee, or automatically using the script.

The individual user, or enrollee, then produces a confidential image file and loads said file into the enrollment workstation 60. If an enrollment officer was present for the earlier steps, the enrollment officer should leave for this and several subsequent steps. The enrollee should perform these steps independently, without being observed. These steps may be accomplished through a script running on the enrollment workstation.

A confidential image file typically was previously generated by the individual user. The user chooses or creates a simple, recognizable image, and saves it on an appropriate media (such as a compact disk, a USB memory stick or thumb drive, or similar portable information storage medium). If the image is created on paper or similar material, it may be scanned or otherwise converted into a standard electronic format.

After the confidential image file is loaded into the enrollment workstation, the software program in the workstation transforms the confidential image file into a file suitable for displaying on the isolated authentication device's display 62. In one exemplary embodiment, where the display is a low-resolution monochrome display, the confidential image file is transformed into a small, low-resolution monochrome file. The transformed confidential image file then is encrypted 64 using the previously-generated public key from the asymmetric key pair.

As a check, the initialization process may then decrypt the encrypted confidential image file using the private key from the key pair, and display the decrypted confidential image file on the enrollment workstation, to ensure that the encryption process was completed correctly 66.

Upon confirmation that the encryption process was completed correctly, all unencrypted versions of the confidential image file (and the original confidential image), both original and transformed, should be deleted, and all storage media on which a copy of the confidential image file was stored should be cleared or wiped 68. In the case of permanent media (such as a compact disk), the media is destroyed.

The next step is to attach the isolated authentication device 2 to the enrollment workstation, and burn 70 the asymmetric key pair, the user's fingerprint data (which may be encrypted), and the encrypted version of the confidential image file into the read-only or protected nonvolatile memory in the isolated authentication device 2. This step may be taken by the user, or by the enrollment officer, if any. Encrypted password and/or personal identification number (PIN) data also may be burned into the read-only or protected nonvolatile memory. The user then tests the isolated authentication device by performing various signing and encryption functions to ensure that the above data is correct 72. If not correct, this step may be repeated. Upon confirmation that the above data is correct and the device is properly functioning, the isolated authentication device may be write-protected by permanently removing a part of the internal circuit necessary for burning data into the read-only or nonvolatile memory 74. In one exemplary embodiment, this is accomplished by pulling on a tab. The initialization process is then complete, and the isolated authentication device 2 is ready for normal use and operation.

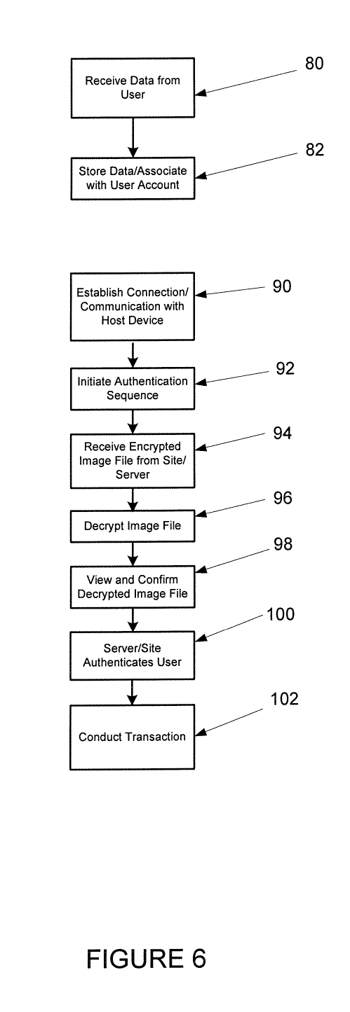

In operation, as seen in FIG. 6, the isolated authentication device 2 may be used to authenticate the identity of its user and establish the authenticity of Web sites, FTP site, servers, P2P clients, and other resources or network resources. The user first provides his or her encrypted confidential image file to a party with which the user wishes to do business or otherwise communicate securely (the “server operator”) 80. The transfer may be performed in person, by postal mail, or by other offline or secure online means. The server operator loads or stores the encrypted confidential image file in a manner where said image file can be associated with that user 82. For example, the encrypted confidential image file may be loaded into a directory associated with the user's account. Similarly, encrypted password or PIN data may be provided.

When the user of the isolated authentication device 2 subsequently desires to communicate or do business with the server operator through a host device, such as a personal computer, the user first establishes a connection 90 between the host device and the isolated authentication device 2. The user then initiates the authentication sequence 92. This can be accomplished by entering a key or command sequence or pushing a button or switch on the isolated authentication device 2. This causes the appropriate encrypted confidential image file to be transferred 94 from the server to the user's isolated authentication device 2. The transfer may be accomplished using a tunneling protocol such as Secure Sockets Layer (SSL). The encrypted image file received from the server is decrypted 96 by the isolated authentication device 2 using the user's public key, and the decrypted file is displayed on the isolated authentication device 2. If the user recognizes 98 the displayed image as the one that was provided during the initiation or enrollment process, the user can be confident that the server or other device to which he or she is connected is one operated by the server owner who was originally provided with the encrypted confidential image file.

The server operator can also authenticate the identity of the user in several ways 100. The authentication may be two or three factor authentication (i.e., possession, fingerprint, and password or personal identification number).

Once both parties have been authenticated, the tunnel goes from the server to the isolated authentication device 2. The host device to which the isolated authentication device 2 is attached or is in communication with may be given information that has been transferred over the connection 102. No image, password, PIN, or biometric information that is unencrypted ever leaves the isolated authentication device 2, which is controlled by the constrained operating system.

The constrained operating system manages all the functions of the isolated authentication device 2. These functions include authentication functions, such as verifying that a fingerprint from an attached or incorporated fingerprint reader matches the fingerprint contained in internal nonvolatile memory, and receiving and verifying a PIN or password entered on the attached or incorporated keypad. Another function is data transfer, including receiving data from and sending data to properly authenticated entities (such as a host device or remote device or server), and exporting the public key. The constrained operating system also performs a variety of cryptographic functions, including performing hash functions on files provided to it by a properly authenticated entity, encrypting small files (such as hashes) using its private key, producing a symmetric session key when asked to do so by a properly authenticated entity, receiving a symmetric session key produced by a properly authenticated entity, and performing symmetric encryption and decryption functions.

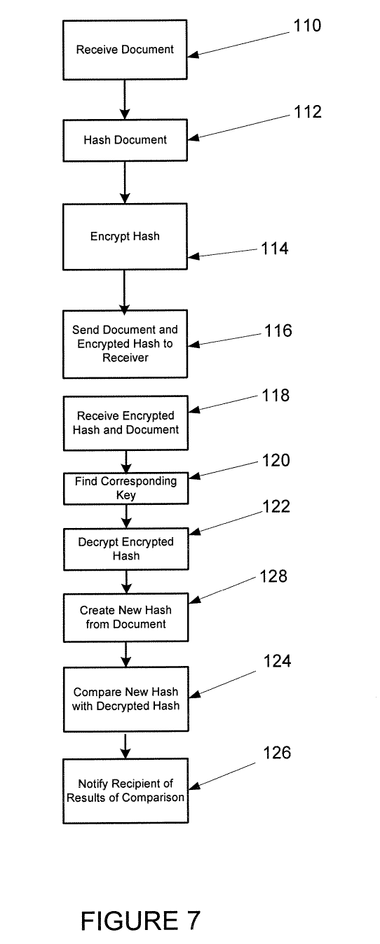

As shown in FIG. 7, the isolated authentication device 2 may be used to digitally sign a document. A document produced externally to the isolated authentication device 2 is sent 110 to the device 2 where it is “hashed” 112 by the processor 22 using any of a variety of hashing algorithms known in the art, such as but not limited to MD5. The result is a short string of characters called a “hash” with no recognizable pattern. The hash is then encrypted 114 with the appropriate private key in the isolated authentication device 2. There may be separate key pairs for one-, two-, or three-factor authentication, depending on the level of security required. In one exemplary embodiment, a private key is always available for use by whoever happens to be in possession of the device (one-factor authentication), while two-factor authentication requires possession plus fingerprint confirmation or PIN. Three-factor authentication, in turn requires possession, PIN, and fingerprint confirmation for a particular private key to be released for use.

The encrypted hash is used as the digital signature. The document and the digital signature may be sent to a recipient 116. The recipient's software or program receives the document and encrypted hash 118, and recognizes the document as a signed document and automatically runs the same hash algorithm on the document 128 (this step may be performed at any time after receipt 118 and prior to comparison 124), looks up the sender's public key that corresponds to the security level used 120, uses that public key to decrypt the digital signature 122, compares the hash produced with the decrypted signature (which should be identical) 124, and notifies the recipient whether the digital signature is, in fact, valid 126.

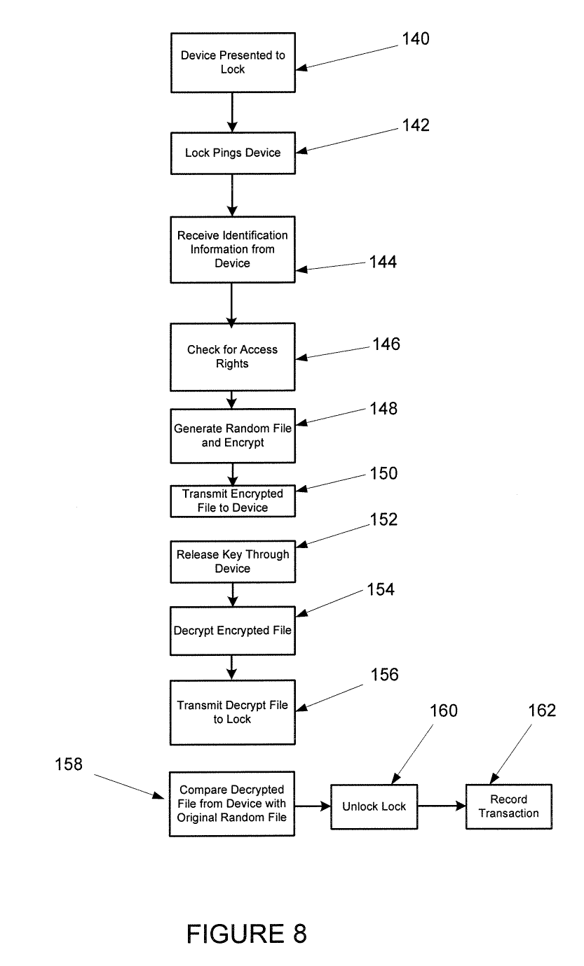

As shown in FIG. 8, the isolated authentication device 2 may be used as a key for a lock. First, the user presents 140 the device 2 to a digital lock. The digital lock may be similar to digital locks such as those used by HID devices, which may use RFID to sense proximity and initiate a “ping”. The lock pings or sends a signal 142, such as a wake-up signal, to the isolated authentication device 2. The device responds 144 by transmitting a signal, such as a serial number or a public key, identifying the device. The lock then queries 146 a database, which may be local or remote, to verify that the device 2 is included in an appropriate access control list, and thus its user or owner has authorization to open that particular lock at that particular date and time. If that condition is met, the lock generates a random digital file and encrypts it 148 using the public key associated with that isolated authentication device 2 and the desired level of security. As noted above, there may be separate key pairs for one-, two-, or three-factor authentication, depending on the level of security required. Thus, for example, the encrypted digital file is sent 150 to the device 2, and the user touches the fingerprint reader and/or enters a PIN, which releases 152 the appropriate private key for use. The private key on the device 2 is then used to decrypt 154 the digital file. The decrypted file is sent 156 back to the lock. If the decrypted file matches 158 the file that was originally generated by the lock, then the lock system knows that the device 2 is in possession of the owner whose public key appears in its database. The lock then unlocks and allows access 160. The lock system also may record 162 the events in a journal or some other form, and may send out appropriate notifications. Similarly, an authentication failure event may also be recorded and notifications sent.

In a similar fashion, the device 2 may be used as a digital birth certificate, as a digital wallet, or a repository for personal information, including financial and medical information.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A method for using an authentication device, comprising the steps of:
receiving a document in electronic form;
creating a hash based on the document with a processor in the authentication device;
encrypting the hash with a private key in the authentication device; and
forwarding or send the document with the encrypted hash.

2. The method of claim 1, wherein the private key is paired with a public key.

3. The method of claim 2, wherein the private and public key pair is associated with a particular level of security.

4. The method of claim 1, wherein encryption of the hash requires additional authentication by the user.

5. The method of claim 4, wherein said additional authentication comprises the user entering a personal identification number or password on the authentication device.

6. The method of claim 4, wherein said additional authentication comprises fingerprint confirmation by means of a fingerprint reader in the authentication device.

7. The method of claim 4, wherein said additional authentication comprises the user entering a personal identification number or password on the authentication device, and fingerprint confirmation by means of a fingerprint reader in the authentication device.

8. A method of using an authentication device, comprising the steps of:
receiving a document in electronic form accompanied by an encrypted hash, said encrypted hash created by an authentication device based on the document and a private key;
decrypting the encrypted hash using the public key corresponding to the private key;
creating a confirmation hash based on the document using the same hash algorithm used by the authentication device; and
comparing the confirmation hash with the decrypted hash.

9. A method of using an authentication device, comprising the steps of:
receiving a signal from an authentication device by a lock to identify the authentication device;
verifying that the authentication device or its user is authorized to open the lock;
generating a random digital file and encrypting it using a public key associated with the authentication device;
sending the encrypted digital file to the authentication device for decryption using a private key paired with the public key;
receiving the decrypted digital file from the authentication device; and
unlocking the lock if the decrypted digital file from the authentication device matches the random digital file initially generated.

10. The method of claim 9, wherein the signal is a public key.

11. The method of claim 9, wherein the private and public key pair is associated with a particular level of security.
